(19) United States
(12) Patent Application Publication
(10) Pub. No.: US 2009/0263560 A1
(43) Pub. Date: Oct. 22, 2009

(54) Method for processing a foodstuff compound

(76) Inventors: Peter BRAUN, Kreuzlingen (CH); Thomas Bischof, Lustenau (AT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/426,135

(22) Filed: Apr. 17, 2009

(30) Foreign Application Priority Data
Apr. 18, 2008 (DE) 10 2008 001 271.8

(51) Int. Cl. A23D 9/007; A23D 9/04

(52) U.S. Cl. 426/613; 426/417; 426/601

(57) ABSTRACT

The invention relates to the processing of a foodstuff compound, in particular a fat compound containing suspended particles; mechanical energy is introduced into the compound by means of a relative movement between the compound to be processed, which is contained in a processing space, and the surface of a processing unit contacting the compound. In accordance with the invention, at least one part of the complete surface of the processing unit, which is in contact with the compound and moved relative to the compound, is comprised of a non-metallic material, preferably a ceramic material.

The invention relates to a method for processing a foodstuff compound, in particular a fat compound containing suspended particles such as cocoa or chocolate compound.

An important representative of such compounds is chocolate or foodstuffs similar to chocolate, which, depending on type, contain different portion quantities of cocoa particles and sugar particles that are suspended in a fat compound, which, again depending on type, contains different portion quantities of vegetable fat (such as cocoa butter, cocoanut fat and the like) or animal fats (such as milk powder, for example).

Such compounds are generally produced from cocoa beans. The cocoa beans are first sterilized and then broken into fragments, the shell is removed, and the core fragments (cocoa nibs) are then roasted and finally ground in grinders, which releases the fat bonded in the cocoa beans and results in a fluid fat compound with cocoa particles suspended therein.

Typically, the cocoa bean fragments contain 20 to 40 ppm (and/or mg/kg) metal particles, preferable at the surface, which originate in the abrasion from metal machine components that come into contact with the core fragments during the production (such as the rough breaking in the breaker, aroma development in the roaster, etc.). This metal portion increases even further during the further processing (grinding in the agitator ball mill, fine grinding in the rolling mill). Typically, this results in cocoa compounds with a metal content of over 50 ppm (one-step grinding) and up to about 100 ppm or even higher (two-step grinding).

The invention is based on the problem of providing a foodstuff compound, in particular a fat compound containing suspended particles, such as a cocoa or chocolate compound, which has a metal portion that is as low as possible, even if the suspended particles are very fine.

The object of the invention is attained in accordance with claim 1, in that with a method for processing a foodstuff compound, in particular a fat compound containing suspended particles, mechanical energy is introduced into the compound by means of a relative movement between the compound to be processed, which is contained in a processing space, and a surface that is in contact with the compound. In accordance with the invention, at least one part of the entire surface of the processing unit in contact with the compound and moved relative to the compound is comprised of a non-metallic material. In this way, even with a long and intensive processing as it is required for the processing of a very fine cocoa or chocolate compound, the metal portion in the final compound can be kept low.

Usefully, it is also possible to use loose auxiliary bodies in the compound in the processing space, which are moved by the relative movement between the compound and the surface in contact with the compound, which leads to a relative movement between the auxiliary bodies and the compound. Preferably, at least the surface of the loose auxiliary bodies consists of a non-metallic material. This guarantees that at least no metallic abrasion originates from the loose auxiliary bodies (grinding auxiliary bodies, grinding balls, grinding beads).

It is especially advantageous if the non-metallic material is a ceramic material and/or comprises ceramic components. This may be an at least partial ceramic coating of areas of the processing unit that are at risk of abrasion.

Preferably, the loose auxiliary bodies are comprised of a ceramic material. In that respect, the invention proceeds from the knowledge that a large part (about 85%) of the metal portion introduced into the cocoa compound in a stirrer ball mill is attributable to abrasion from the metallic grinding balls during the grinding. This can be prevented with ceramic grinding bodies.

Even all surfaces of the processing space exposed to the compound to be processed can be comprised of ceramic material.

Sintered metal oxides such as ZrO₂, HfO₂, MgO and Y₂O₃ or combinations thereof can be used as ceramic material. Spherical or near spherical auxiliary grinding bodies of ceramic material, which are preferably comprised of mixed oxide having ZrO₂, HfO₂ or MgO and contain 2% to 8% Y₂O₃ have proven to be especially resistant to abrasion. Especially preferred are ceramic grinding bodies with a portion of 92% to 98% ZrO₂ and HfO₂ as well as a further portion of 2% to 8% Y₂O₃. The diameters of the grinding bodies are preferably in a range of 2 mm to 8 mm and especially preferably in a range of 5 mm to 8 mm.

In a special embodiment of the invention, the processing unit has a rotor-stator machine; the processing space between the rotor and the stator is limited in said machine, with the relative movement between the compound and the surface contacting the compound occurring by rotating the rotor relative to the stator, and with at least one part of the rotor surface and/or stator surface pointing into the processing space being comprised of non-metallic material. In this way, even with two-step grinding, the metal portion in the foodstuff compound can be kept to a minimum in the production of very fine cocoa or chocolate compounds.

In another special embodiment, the processing unit has at least two cylinder rollers; the processing space is formed between and on said cylinder rollers, i.e. in the roller gap and on the cylinder surfaces, with the relative movement between the compound and the surface contacting the compound occurring by rotating the two cylinder rollers, and with at least one portion of the roller surfaces being comprised of a non-metallic material. In this way, little abrasion enters the compound during the shearing and/or squeezing. In the production of very fine cocoa or chocolate compound, the metal portion in the foodstuff can therefore be kept to a minimum even with two-step roller mill grinding.

The invention also relates to a foodstuff compound, in particular a fat compound containing suspended particles, which has a metal content of less than 60 mg of metal per kg of suspended particles in the foodstuff compound, and preferably a metal content of less than 40 mg metal per kg of suspended particles in the foodstuff compound.

Preferably, the foodstuff compound in accordance with the invention has a metal oxide content of les than 1 mg metal oxide per kg of suspended particles in the foodstuff compound, and preferably a metal oxide content of less than 0.5 mg metal oxide per kg suspended particles in the foodstuff compound.

In a special embodiment, the foodstuff compound contains suspended cocoa particles and/or sugar particles.

For these chocolates in accordance with the invention, it applies correspondingly that they have a metal content of less than 60 mg metal per cocoa portion in the foodstuff compound, and preferably a metal content of less than 40 mg metal per cocoa portion in the foodstuff compound. All components that originate in the cocoa, i.e. cocoa particles with fat bonded in said cocoa particles (“cocoa powder”) as well as free cocoa fat (“cocoa butter”) are considered cocoa portions. The remainder of the foodstuff compound, in particular the chocolate, is formed by other components, such as sugar particles, milk fat and/or milk powder, lecithin and the like.

Correspondingly, it applies for these chocolates in accordance with the invention that they have a metal oxide content of less than 1 mg metal oxide per kg of cocoa portion in the foodstuff compound, and preferably a metal oxide content of less than 0.5 mg metal oxide per kg cocoa portion in the foodstuff compound.

The foodstuff compound in accordance with the invention is preferably produced by means of one of the methods described above.

1. Method for processing a foodstuff compound, in particular a fat compound containing suspended particles, with mechanical energy being introduced into the compound by means of a relative movement between the compound to be processed, which is contained in a processing space, and the surface of a processing unit that is in contact with the compound, characterized in that at least one part of the entire surface of the processing unit, which is in contact with the compound and moved relative to the compound, is comprised of a non-metallic material, preferably a ceramic material.

2. Method in accordance with claim 1, characterized in that furthermore, the compound in the processing space contains loose auxiliary bodies that are moved by the relative movement between the compound and the surface contacting the compound; a relative movement occurs between the auxiliary bodies and the compound, and at least the surface of the loose auxiliary bodies is comprised of a non-metallic material.

3. Method in accordance with claim 1 or 2, characterized in that the non-metallic material is a ceramic material.

4. Method in accordance with claim 2 or 3, characterized in that the loose auxiliary bodies are comprised of a ceramic material.

5. Method in accordance with one of the claims 1 to 4, characterized in that the processing unit has a rotor-stator machine, and that the processing space between the rotor and the stator is limited in said machine; the relative movement between the compound and the surface contacting the compound occurs when the rotor rotates relative to the stator; at least one part of the rotor surface and/or the stator surface pointing into the processing space is comprised of non-metallic material.

6. Method in accordance with one of the claims 1 to 4, characterized in that the processing unit has at least two cylinder rollers between which (roller gap) and on which (cylinder surface) the processing space is formed; the relative movement between the compound and the surface area contacting the compound occurs by rotating the two cylinder rollers; at least one part of the roller surface areas is comprised of a non-metallic material (scissors and/or squeezes)

7. Foodstuff compound, in particular fat compound containing suspended particles, characterized in that the compound has a metal content of less than 60 mg metal per kg of particles suspended in the foodstuff compound.

8. Foodstuff compound in accordance with claim 7, characterized in that it has a metal oxide content of less than 1 mg metal oxide per kg of particles suspended in the foodstuff compound.

9. Foodstuff compound in accordance with claim 7 or 8, characterized in that it contains suspended cocoa particles and a metal content of less than 60 mg metal per kg of cocoa portion (=quantity of all cocoa components) in the foodstuff compound.

10. Foodstuff compound in accordance with claim 9, characterized in that it has a metal oxide content of less than 1 mg metal oxide per kg of cocoa portion in the foodstuff compound.

11. Foodstuff compound in accordance with one of the claims 7 to 10, characterized in that it contains suspended sugar particles.

12. Foodstuff compound in accordance with one of the claims 7 to 11, characterized in that it was produced by means of a method in accordance with one of the claims 1 to 6.
